(19) United States
(12) Patent Application Publication
(10) Pub. No.: US 2024/0429653 A1
(43) Pub. Date: Dec. 26, 2024

(54) MOUNTING ASSEMBLY FOR AN ELECTRICAL CONNECTOR

(71) Applicants: TE Connectivity Brasil Industria De Eletronicos LTDA, Braganca Paulista (BR); TE Connectivity Solutions GmbH, Schaffhausen (CH)

(72) Inventors: Natanael Marcondes dos Santos, Braganca Paulista (BR); Gustavo Bonucci, Braganca Paulista (BR); Rafael Kazuo Sato T. Leme, Braganca Paulista (BR); Dinesh Loku Hemnani, Greensboro, NC (US); Michael Dale Brown, Winston Salem, NC (US)

(21) Appl. No.: 18/649,776

(22) Filed: Apr. 29, 2024

Related U.S. Application Data
(60) Provisional application No. 63/509,536, filed on Jun. 22, 2023.

(51) Int. Cl. H01R 13/629; H01R 13/514; H01R 13/52

(52) U.S. Cl. CPC H01R 13/62955; H01R 13/514; H01R 13/5202

(57) ABSTRACT

An electrical connector includes a housing having a shroud surrounding a cavity at a mating end and a base with a flange at a mounting end configured to be mounted to a mounting surface of a panel. The electrical connector includes a contact assembly received in the housing having contact configured to be mated to a mating electrical connector. The electrical connector includes a seal coupled to the flange and surrounding the base. The seal is configured to interface with the mounting surface of the panel. The electrical connector includes a locking lever coupled to the housing. The locking lever is configured to interface with the panel to secure the housing to the panel.

### CROSS REFERENCE TO RELATED APPLICATIONS

This application claims the benefit of U.S. Provisional Application No. 63/509,536, filed 22 Jun. 2023, the subject matter of which is herein incorporated by reference in its entirety.

### BACKGROUND OF THE INVENTION

The subject matter herein relates generally to electrical connectors.

Connector systems use electrical connectors to interconnect various components. Some connector systems transmit power and or data from one component to another component. For instance, power connectors may be used to connect a power source, such as a battery, to a load, such as a motor. For example, in an electric vehicle, the battery may be connected to the invertor or electric motor through a plug connector and a header connector. The header connector is mounted to one of the components, such as the motor, and the plug connector is provided at an end of a cable harness routed between the batter and the plug connector. Connection of the header connector to the component involves bolting a mounting flange of the header connector to a panel or other structure of the component. For example, four bolts may be used in four corners of the mounting flange. Bolted connections require assembly time and hardware, such as nuts and bolts, to make the connection between the header connector and the structure.

A need remains for a connector system having a boltless and reliable connection between the electrical connector and the structure.

### BRIEF DESCRIPTION OF THE INVENTION

In one embodiment, an electrical connector is provided and includes a housing extending between a mating end and a mounting end. The mating end configured to be mated with a mating electrical connector. The mating end includes a shroud surrounding a cavity. The mounting end is configured to be mounted to a panel. The mounting end includes a base and a flange extending from the base. The base of the housing is received in an opening in the panel. The flange of the housing is mounted to a mounting surface of the panel. The electrical connector includes a contact assembly received in the housing. The contact assembly includes a contact holder holding at least one contact configured to be mated to the mating electrical connector. The electrical connector includes a seal coupled to the flange and surrounding the base. The seal is configured to interface with the mounting surface of the panel. The electrical connector includes a locking lever coupled to the housing. The locking lever is configured to interface with the panel to secure the housing to the panel.

In another embodiment, an electrical connector is provided and includes a housing extending between a mating end and a mounting end. The mating end is configured to be mated with a mating electrical connector. The mating end includes a base surrounding a cavity. The mounting end is configured to be mounted to a panel. The mounting end includes a base and a flange extending from the base. The base of the housing is received in an opening in the panel. The flange of the housing is mounted to a mounting surface of the panel. The housing includes a pre-stage latch and a final stage latch. The flange of the housing is moved relatively closer to the mounting surface of the panel from a pre-stage position to a final stage position. The pre-stage latch is latchably coupled to the panel in the pre-stage position. The final stage latch is latchably coupled to the panel in the final stage position. The electrical connector includes a contact assembly received in the housing. The contact assembly includes a contact holder holding at least one contact configured to be mated to the mating electrical connector. The electrical connector includes a seal coupled to the flange and surrounds the base. The seal configured to interface with the mounting surface of the panel. The electrical connector includes a locking lever coupled to the housing. The locking lever is configured to interface with the panel to secure the housing to the panel. The locking lever is actuated to move the housing from the pre-stage position to the final stage position.

In a further embodiment, an electrical connector is provided and includes a housing extending between a mating end and a mounting end. The mating end is configured to be mated with a mating electrical connector. The mating end includes a base surrounding a cavity. The mounting end is configured to be mounted to a panel. The mounting end includes a base and a flange extending from the base. The base of the housing is received in an opening in the panel. The flange of the housing is mounted to a mounting surface of the panel. The electrical connector includes a contact assembly received in the housing. The contact assembly includes a contact holder holding at least one contact configured to be mated to the mating electrical connector. The electrical connector includes a seal coupled to the flange and surrounds the base. The seal is configured to interface with the mounting surface of the panel. The electrical connector includes a locking lever coupled to the housing. The locking lever is configured to interface with the panel to secure the housing to the panel. The locking lever includes a locking element. The locking element is actuated to lock the locking lever to the housing.

### BRIEF DESCRIPTION OF THE DRAWINGS

FIG. 1 is a perspective view of an electrical connector system utilizing mounting features in accordance with an exemplary embodiment.

FIG. 2 is a top perspective view of a portion of the electrical connector system showing a portion of the header connector in accordance with an exemplary embodiment.

FIG. 3 is a bottom perspective view of a portion of the electrical connector system showing the header connector in accordance with an exemplary embodiment mounted to the panel.

FIG. 4 is a cross-sectional view of a portion of the header connector in accordance with an exemplary embodiment.

FIG. 5 is an enlarged cross-sectional view of a portion of the header connector in accordance with an exemplary embodiment.

FIG. 6 is a bottom perspective view of a portion of the header connector in accordance with an exemplary embodiment.

FIG. 7 is a bottom perspective view of a portion of the header connector showing the locking lever in an open position in accordance with an exemplary embodiment.

FIG. 8 is a bottom perspective view of a portion of the header connector showing the locking lever in a closed position in accordance with an exemplary embodiment.

FIG. 9 is a sectional view of a portion of the header connector showing the locking lever in the closed position and in an extended position in accordance with an exemplary embodiment.

FIG. 10 is a bottom perspective view of a portion of the header connector showing the locking lever in a retracted position in accordance with an exemplary embodiment.

FIG. 11 is a bottom perspective view of a portion of the header connector showing the locking lever in a locked position in accordance with an exemplary embodiment.

FIG. 12 is a cross-sectional view of a portion of the header connector showing the locking lever in a locked position in accordance with an exemplary embodiment.

FIG. 13 is a cross-sectional view of a portion of the header connector showing the locking lever in a locked position in accordance with an exemplary embodiment.

FIG. 14 is a cross-sectional view of a portion of the header connector showing the locking lever in a locked position in accordance with an exemplary embodiment.

FIG. 15 is a cross-sectional view of a portion of the header connector in accordance with an exemplary embodiment.

FIG. 16 is a cross-sectional view of a portion of the header connector in accordance with an exemplary embodiment.

FIG. 17 is a cross-sectional view of a portion of the header connector in accordance with an exemplary embodiment.

### DETAILED DESCRIPTION OF THE INVENTION

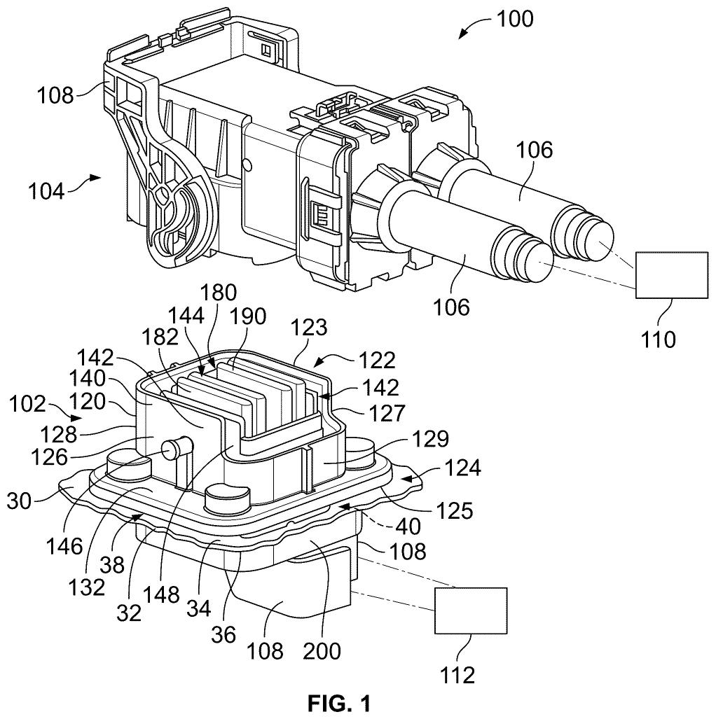

FIG. 1 is a perspective view of an electrical connector system 100 utilizing mounting features in accordance with an exemplary embodiment. In an exemplary embodiment, the mounting features include a locking lever 200. The electrical connector system 100 is an exemplary system utilizing the locking lever 200 and the subject matter herein is not intended to be limited to use with the illustrated electrical connector system 100.

The electrical connector system 100 includes electrical connectors 102, 104 configured to be mated at a separable mating interface. In an exemplary embodiment, the electrical connectors 102, 104 are a header connector 102 and a plug connector 104, respectively. The plug connector 104 is a mating electrical connector configured to be mated with the header connector 102. The plug connector 104 is shown poised for mating with the header connector 102.

The header connector 102 is mounted to a structure 30 of a component. In an exemplary embodiments, the structure 30 is a panel 32 having an upper surface 34 and a lower surface 36. The panel 32 has a mounting area 38 and the header connector 102 is configured to be mounted to the panel 32 at the mounting area 38. In an exemplary embodiment, the panel 32 includes an opening 40 at the mounting area 38. The header connector 102 is received in the opening 40 and mounted to the panel 32 at the mounting area 38. In an exemplary embodiment, the panel 32 is conductive. For example, the panel 32 may be manufactured from a metal material, such as steel. The panel 32 may be a piece of sheet metal. In an exemplary embodiment, the panel 32 is a coated structure wherein one or more layers of the panel are coated layers. In an exemplary embodiment, the mounting features of the header connector 102 allow mounting to the panel 32 by a boltless and/or toolless connection. For example, the header connector 102 may be secured using a locking lever that secures the header connector 102 to the panel 32 without the use of bolts or other fasteners.

In an exemplary embodiment, the electrical connector system 100 is a high power connector system that is used to transfer power between various components as part of a high power circuit. In a particular application, the electrical connector system 100 is a battery system, such as a battery system of a vehicle, such as an electric vehicle or hybrid electric vehicle; however, the electrical connector system 100 is not intended to be limited to such battery systems.

The plug connector 104 is configured to be electrically connected to a component 110, such as through one or more power cables 106. For example, the plug connector 104 may be electrically connected to a battery, a charger, an inverter, an electric motor or another type of component. The header connector 102 is configured to be electrically connected to a component 112, such as through a power bus 108; however the header connector 102 may be electrically connected to the component 112 by other means, such as a terminal, power wire or other connector. For example, the header connector 102 may be electrically connected to a battery pack, such as through a battery distribution unit, a manual service disconnect, a charger, an inverter, an electric motor, or another type of component. The battery distribution unit may manage the power capacity and functionality of the electrical connector system 100, such as by measuring current and regulating power distribution of the battery pack.

In the illustrated embodiment, the electrical connector system 100 is a right angle connector system where the connectors 102, 104 are mated in a direction perpendicular to the power wires 106. However, the power wires 106 may extend from the plug connector 104 in a direction parallel to the mating direction in alternative embodiments. In various embodiments, the meting direction is a vertical mating direction. For example, the plug connector 104 is mated to the header connector 102 in a vertically downward direction. Optionally, the plug connector 104 may be removably coupled to the header connector 102 to disconnect the high power circuit of one or more of the components, such as the battery pack, the electric motor, the inverter, or other components of the vehicle, such as for maintenance, repair or for another reason. When mated, one or more header contacts of the header connector 102 are mated with corresponding plug terminals of the plug connector 104, such as at mating interfaces thereof.

The header connector 102 includes a header housing 120 and a contact assembly 180. The header housing 120 holds the contact assembly 180. The contact assembly 180 is configured to be mated with the plug connector 104 to make an electrical connection with the plug connector 104. The contact assembly 180 is configured to be electrically connected to the component 112, such as by a busbar, a cable, wires, or other types of electrical connectors.

The header housing 120 has a mating end 122 at a top 123 of the header housing 120 and a mounting end 124 at a bottom 125 of the header housing 120. The header housing 120 includes a base 130 at the mounting end 124 and a shroud 140 extending from the base 130. The shroud 140 is provided at the mating end 122 and surrounds the contact assembly 180. The shroud 140 includes shroud walls 142 surrounding a cavity 144. The cavity 144 receives the contact assembly 180. The shroud walls 142 extend along first and second sides 126, 127 of the header housing 120 and extend along a front 128 and a rear 129 of the header housing 120. As such, the contact assembly 180 is surrounded on all four sides. Optionally, the shroud walls 142 at the rear 129 may be shorter than the shroud walls 142 at the front 128. The shroud walls 142 may include guide features, such as tabs, ribs, or channels extending along the shroud walls 142 to guide mating with the plug connector 104. The shroud 140 is configured to be plugged into the plug connector 104.

In an exemplary embodiment, the shroud 140 includes mounting pins 146 extending from the shroud walls 142. The plug connector 104 is configured to be mounted to the mounting pins 146. For example, a lever 108, which is rotatably coupled to the housing of the plug connector 104, is configured to be coupled to the mounting pins 146.

In an exemplary embodiment, a header shield 148 is coupled to the header housing 120. The header shield 148 may be coupled to the shroud 140 and/or the base 130. The header shield 148 is configured to be electrically connected to the plug connector 104 when the plug connector 104 is coupled to the header connector 102. In an exemplary embodiment, the header shield 148 is configured to be electrically connected to the panel 32 to electrically common the plug connector 104 with the panel 32. The header shield 148 may provide shielding around the contact assembly 180. In an exemplary embodiment, the header shield 148 extends along interior surfaces of the shroud walls 142 optionally, the header shield 148 may extend from the shroud 140 into the base 130. For example, the header shield 148 may wrapped around the base 130 to an exterior of the base 130 to electrically connect to the panel 32.

In an exemplary embodiment, the contact assembly 180 includes a contact holder 182 holding one or more header contacts 190. For example, the header contact 190 may be received in contact channels passing through the contact holder 182. The contact holder 182 is manufactured from a dielectric material to isolate the header contact 190 from each other and from the header shield 148. In the illustrated embodiment, the contact holder 182 is separate and discrete from the header housing 120. However, in alternative embodiments, the contact holder 182 may be integral with the header housing 120 such as being co-molded with the header housing 120. For example, the header housing 120 may be molded with contact channels in the base 130 that receive the header contact 190.

The base 130 holds the contact assembly 180. For example, the contact assembly 180 may be plugged into the base 130. The base 130 may include an opening or channels that receive portions of the contact assembly 180. The base 130 is configured to be mounted to the panel 32. Optionally, the base 130 may extend through the opening 134 such that the base 130 is located both above the upper surface 34 and below the lower surface 36 of the panel 32. In an exemplary embodiment, the base 130 includes a flange 132 extending outward from the base 130. The base 130 is configured to be plugged through the opening 40 in the panel 32. The flange 132 is configured be mounted to the panel 32 at the mounting area 38. For example, the flange 132 faces the upper surface 34 of the panel 32. In an exemplary embodiment, the flange 132 abuts against a mounting surface at the upper surface 34 of the mounting area 38 area. In an exemplary embodiment, a sealed interface is defined between the header connector 102 and the panel 32, such as at the bottom surface of the flange 132 and the upper surface 34 of the panel 32.

In an exemplary embodiment, the mounting features of the header connector 102 are used to mount the flange 132 to the mounting area 38 at the upper surface 34. For example, the locking lever 200 of the header connector 102 is used to secure the header housing 120 to the panel 32. For example, the locking lever 200 may secure the flange 132 to the upper surface 34 of the panel 32. In an exemplary embodiment, the locking lever 200 interfaces with the lower surface 36 of the panel 32 to press the flange 132 into the upper surface 34 of the panel 32 to rigidly secure the header connector 102 to the panel 32. In an exemplary embodiment, the locking lever 200 is pivotably coupled to the header housing 120. For example, the locking lever 200 may be rotated from an open position to a closed position to secure the header connector 102 to the panel 32. In an exemplary embodiment, the rotation of the locking lever 200 from the open position to the closed position tightened the header housing 120 to the panel 32. For example, the flange 132 is pressed downward toward the panel 32 into engagement with the panel 32 to create a tight connection between the header housing 120 and the panel 32. Actuation of the locking lever 200 presses the flange 132 downward to compress the seal between the flange 132 and the upper surface 34 of the panel 32. In an exemplary embodiment, after the locking lever 200 is rotated to the closed position, the locking lever 200 may be slid from an unlocked position to a locked position. For example, in the unlocked position, the locking lever 200 may be freely rotatable between the open and closed positions. In the locked position, the locking lever 200 may be restricted from rotating, thus maintaining the locking lever 200 in the locked position. The locking lever 200 secures the header connector 102 to the panel 32 without the use of fasteners or bolt. The mounting action may be performed manually, by hand or by an assembly machine. A bulbous connection is provided by the locking lever 200.

Other motions or movements may be used in alternative embodiments to securely couple the header connector 102 to the panel 32 without the use of fasteners or bolt. For example, the locking lever 200 may be slidably connected to the header housing 120 rather than rotatably coupled to the header housing 120, and include a ramp or other locking feature to press the header housing 120 downward into engagement with the panel 32 as the locking lever 200 is actuated (for example, during the sliding action the wedge drives the header housing 120 downward).

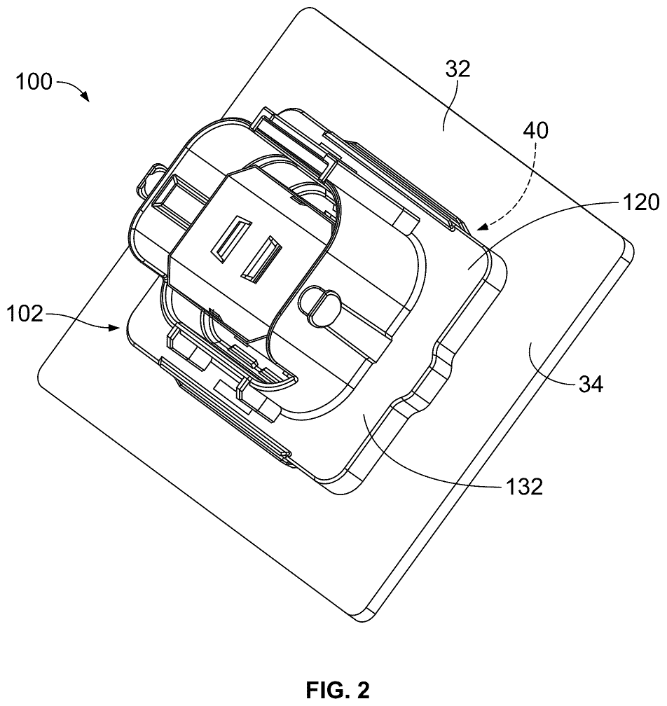

FIG. 2 is a top perspective view of a portion of the electrical connector system 100 showing a portion of the header connector 102 in accordance with an exemplary embodiment. During assembly, the header housing 120 is loaded into the opening 40 in the panel 32 from above. The flange 132 is located above the upper surface 34 of the panel 32. In an exemplary embodiment, a seal (not shown) is located between the flange 132 at the upper surface 34 of the panel 32. During initial assembly, the seal is not compressed. However, after mounting and assembly of the locking lever 200 to the header housing 120, the seal is compressed between the flange 132 and the panel 32. For example, the flange 132 is pulled downward into engagement with the upper surface 34 of the panel 32.

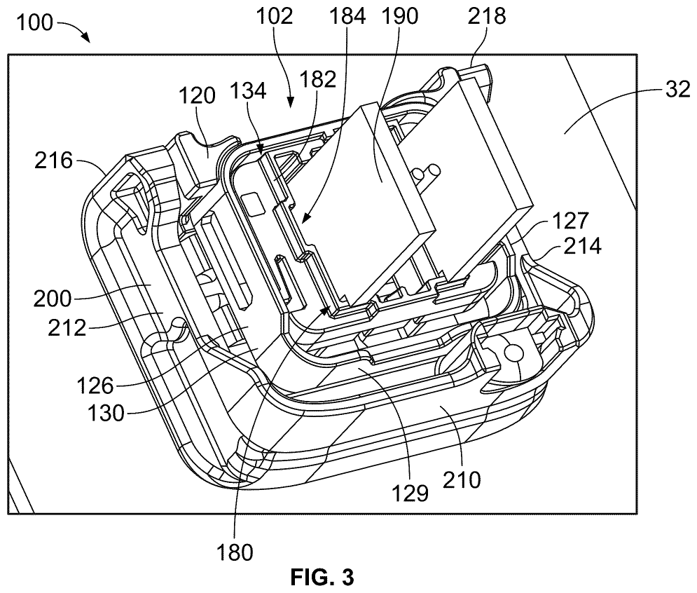

FIG. 3 is a bottom perspective view of a portion of the electrical connector system 100 showing the header connector 102 in accordance with an exemplary embodiment mounted to the panel 32. The locking lever 200 secures the header connector 102 to the panel 32. The panel 32 is captured between the locking lever 200 and the flange for 132. In an exemplary embodiment, the locking lever 200 includes a locking element 202 used to lock the locking lever 200 in the locked position (FIG. 3). The locking element 202 engages the header housing 120 to retain the locking lever 200 in the locked position. In an exemplary embodiment, the locking element 202 is releasable to allow unlocking of the locking lever 200, such as for removal of the header connector 102 from the panel 32 for repair or replacement of parts of the header connector 102.

The contact assembly 180 is shown coupled to the header housing 120 in FIG. 3. For example, the contact holder 182 is received in an opening 134 in the base 130. The contact holder 182 holds the header contacts 190. In the illustrated embodiment, the contact assembly 180 includes a pair of the header contacts 190. Greater or fewer header contacts 190 may be provided in alternative embodiments. In the illustrated embodiment, the header contacts 190 are blade contacts. For example, the header contacts 190 are generally planar plates located in contact channels 184 of the contact holder 182. The header contacts 190 may be busbars configured to be electrically connected to other components. Other types of contacts may be used in alternative embodiments, such as pin contacts, socket contacts, tuning fork contacts, spring beam contacts, or other types of contacts.

In an exemplary embodiment, the locking lever 200 is separate and discrete from the header housing 120. The locking lever 200 is configured to be coupled to the header housing 120, such as to the sides 126, 127 of the header housing 120. Optionally, the locking lever 200 may be removably coupled to the header housing 120. For example, the locking lever 200 may be separably coupled to the header housing 120 and is removable by pulling the locking lever 200 straight off of the header housing 120.

In an exemplary embodiment, the locking lever 200 is U-shaped having a handle 210, a first lever arm 212 extending from a first side of the handle 210 and a second lever arm 214 extending from a second side of the handle 210. The first lever arm 212 extends to a distal end 216. The second lever arm 214 extends to a distal end 218. The first lever arm 212 extends along the first side 126 of the header housing 120. The second lever arm 214 extends along the second side 127 of the header housing 120. In the locked position, the handle 210 extends along the rear 129 of the header housing 120. The locking lever 200 is movable relative to the header housing 120 by pushing or pulling on the handle 210. In an exemplary embodiment, the locking lever 200 is slidable, such as in a horizontal sliding direction, relative to the header housing 120, such as to move the locking lever 200 between a locked position and an unlocked position. The handle 210 is located adjacent the rear 129 in the locked position and is configured to be spaced apart from the rear 129 in the unlocked position. In an exemplary embodiment, the locking lever 200 is rotatable relative to the header housing 120, such as to move the locking lever 200 between an open position and a closed position. The handle 210 is located adjacent the panel 32 of the closed position. The handle 210 is rotated away from the panel 32 in the open position.

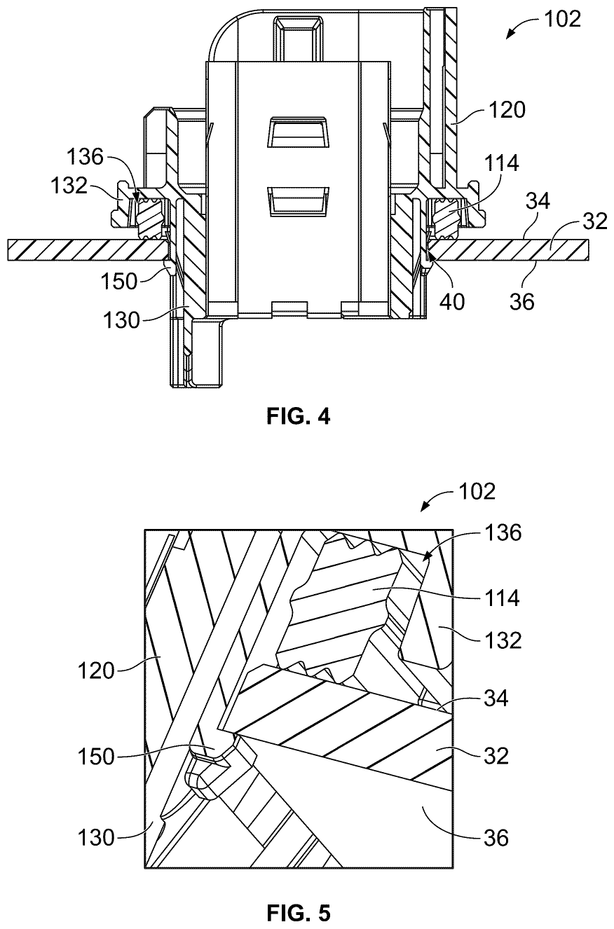

FIG. 4 is a cross-sectional view of a portion of the header connector 102 in accordance with an exemplary embodiment. FIG. 5 is an enlarged cross-sectional view of a portion of the header connector 102 in accordance with an exemplary embodiment. The header connector 102 is shown in a pre-stage position in FIGS. 4 and 5. In the pre-stage position, the header housing 120 is initially positioned relative to the panel 32, such as in the opening 40. The header housing 120 is configured to receive the locking lever 200 in the pre-stage position. The header housing 120 is not fully secured to the panel 32 in the pre-stage position.

In an exemplary embodiment, the flange 132 includes a seal pocket 136 that receives a seal 114. The seal 114 is configured to be sealingly coupled to the header housing 120 and is configured to be sealingly coupled to the panel 32. In various embodiments, the seal 114 may be a rubber gasket. In an exemplary embodiment, the seal 114 is compressible. Compression of the seal 114 creates a tight seal to the header housing 120 and the panel 32. In an exemplary embodiment, the locking lever 200 is used to compress the seal 114 with the locking lever 200 coupled to the header housing 120.

In an exemplary embodiment, the header housing 120 includes pre-stage latches 150 used to secure the header housing 120 in the pre-stage position on the panel 32. The pre-stage latches 150 are configured to be latchably coupled to the panel 32. In an exemplary embodiment, the pre-stage latches 150 extend from the base 130. The pre-stage latches 150 are received in the opening 40 of the panel 32 are configured to be latchably coupled to the lower surface 36. When the pre-stage latches 150 are connected to the panel 32, the bottom of the flange 132 is spaced apart from the upper surface 34 of the panel 32. For example, a gap is provided between the flange 132 and the upper surface 34 of the panel 32. The seal 114 may span across the gap. The seal 114 may hold the header housing 120 and the pre-stage position, such as holding the pre-stage latches 150 latched to the lower surface 36 of the panel 32. When the locking lever 200 is coupled to the header housing 120 the seal 114 is compressed and the pre-stage latches 150 are configured be released from the panel 32. For example, the locking lever 200 may pull the flange 132 toward the panel 32 2 partially or completely enclosed the gap.

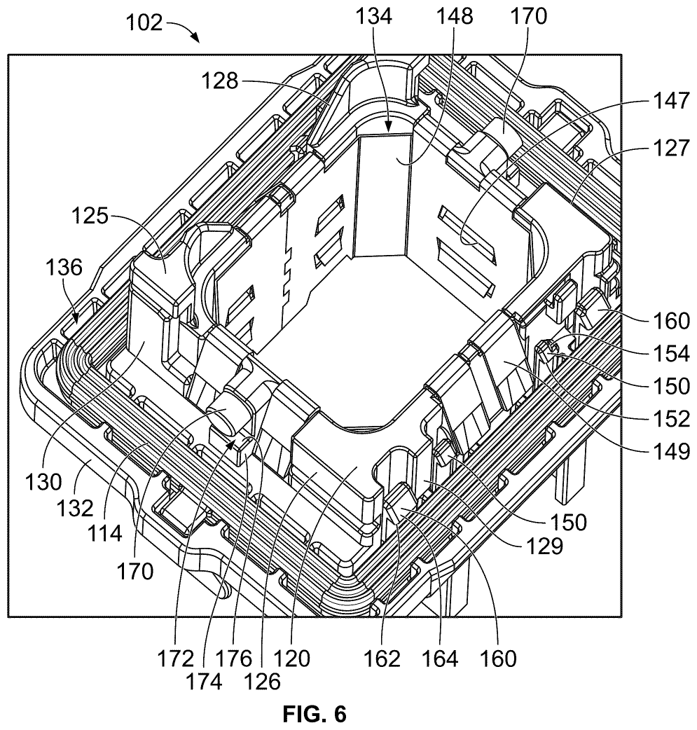

FIG. 6 is a bottom perspective view of a portion of the header connector 102 in accordance with an exemplary embodiment. The header housing 120 is shown in FIG. 6 with the header shields 148 and the seal 114 coupled to the header housing 120. The contact assembly 180 (FIG. 3) is removed for clarity to illustrate portions of the header connector 102.

The seal 114 is received in the seal pocket 136 in the bottom of the flange 132. In an exemplary embodiment, the seal 114 completely surrounds the base 130. For example, the seal 114 is continuous along both sides 126, 27, the front 128, and the rear 129.

In an exemplary embodiment, the header shield 148 is coupled to the base 130. The header shield 148 is located in the opening 134 of the base 130 and extends along the interior of the shroud 140. In an exemplary embodiment, the header shields 148 completely surrounds the opening 134 to provide shielding around the contact assembly 180. The header shield 148 includes connecting tabs 147 extending inward from the walls of the header shield 148 to interface with the plug connector 104. The connecting tabs 147 may be located along the sides and/or the front and/or the rear of the header shield 148. The header shield 148 includes panel tabs 149 extending outward from the walls of the header shields 148 to interface with the panel 32. The panel tabs 149 may be located along the sides and/or the front and/or the rear of the header shields 148.

In an exemplary embodiment, the header housing 120 includes the pre-stage latches 150. In the illustrated embodiment, the pre-stage latches 150 are located along the front and rear 128, 129 of the base 130. Other locations are possible in alternative embodiments. The pre-stage latches 150 may extend from the flange 132 along the base 130. In alternative embodiments, the pre-stage latches 150 may extend from the base 130. The pre-stage latches 150 are deflectable relative to the base 130. For example, the pre-stage latches 150 may be deflected inward toward the base 130 to pass through the opening 40 in the panel 32, such as during mating to and unmated from the panel 32. Each pre-stage latch 150 includes a latch surface 152. The latch surface 152 is located along the outer side of the pre-stage latch 150. The latch surface 152 faces outward. For example, the latching surface 152 faces the flange 132. The panel 32 is configured to be captured between the latch surface 152 and the flange 132. Optionally, the pre-stage latch 150 includes a ramp surface 154 below the latch surface 152. The ramp surface 154 is configured to engage the panel 32 to deflect the pre-stage latch as the header housing 120 is loaded through the opening 40 in the panel 32.

In an exemplary embodiment, the header housing 120 includes final stage latches 160. The final stage latches 160 are configured to be latchably coupled to the panel 32. The final stage latches 160 are used to secure the header housing 120 in a final stage, such as holding the flange 132 against the panel 32. In the final stage, the seal 114 is compressed and sealingly coupled to the flange 132 and the panel 32. In the illustrated embodiment, the final stage latches 160 are located along the front and rear 128, 129 of the base 130. Other locations are possible in alternative embodiments. The final stage latches 160 may extend from the flange 132 along the base 130. In alternative embodiments, the final stage latches 160 may extend from the base 130. The final stage latches 160 are deflectable relative to the base 130. For example, the final stage latches 160 may be deflected inward toward the base 130 to pass through the opening 40 in the panel 32, such as during mating to and unmated from the panel 32. Each final stage latch 160 includes a latch surface 162. The latch surface 162 is located along the outer side of the final stage latch 160. The latch surface 162 faces outward. For example, the latching surface 162 faces the flange 132. The panel 32 is configured to be captured between the latch surface 162 and the flange 132. Optionally, the final stage latch 160 includes a ramp surface 164 below the latch surface 162. The ramp surface 164 is configured to engage the panel 32 to deflect the final stage latch as the header housing 120 is loaded through the opening 40 in the panel 32.

In an exemplary embodiment, the header housing 120 includes lever pins 170 extending outward from the base 130. The locking lever 200 is configured to be coupled to the lever pins 170. The locking lever 200 may be rotatably coupled to the lever pins 170 and/or slidably coupled to the lever pins 170. In the illustrated embodiment, the lever pins 170 are located at the sides 126, 127 of the base 130. Other locations are possible in alternative embodiments. In an exemplary embodiment, the lever pins 170 are spaced apart from the flange 132. For example, the lever pins 170 may be located near the bottom 125 of the header housing 120. In various embodiments, the lever pins are cylindrical. However, the lever pins 170 may have other shapes in alternative embodiments.

In an exemplary embodiment, the header housing 120 includes a guide track 172 to guide relative movement of the locking lever 200 relative to the header housing 120. For example, the guide track 172 is used to guide rotating movement of the locking lever 200 relative to the header housing 120. In an exemplary embodiment, the header housing 120 includes one or more guide rails 174 having guide surfaces 176 used to form the guide track 172. Optionally, the lever pin 170 may form a portion of the guide track 172. For example, the guide track 172 may be defined between the guide surface 176 of the guide rail 174 and the lever pin 170. Other types of guide features may be used to guide movement of the locking lever 200 relative to the header housing 120.

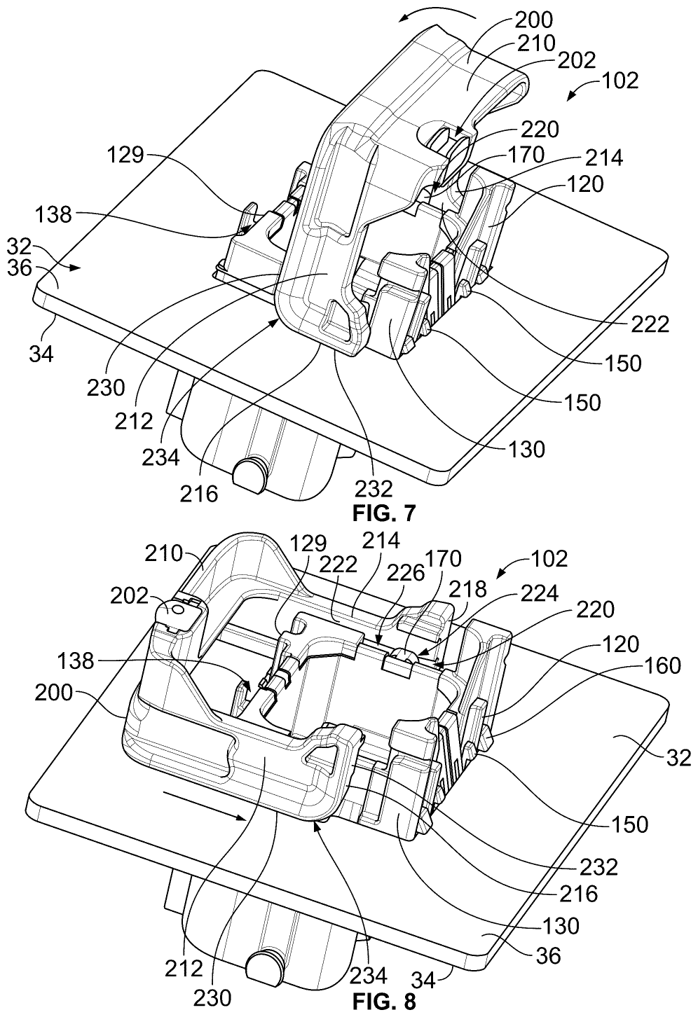

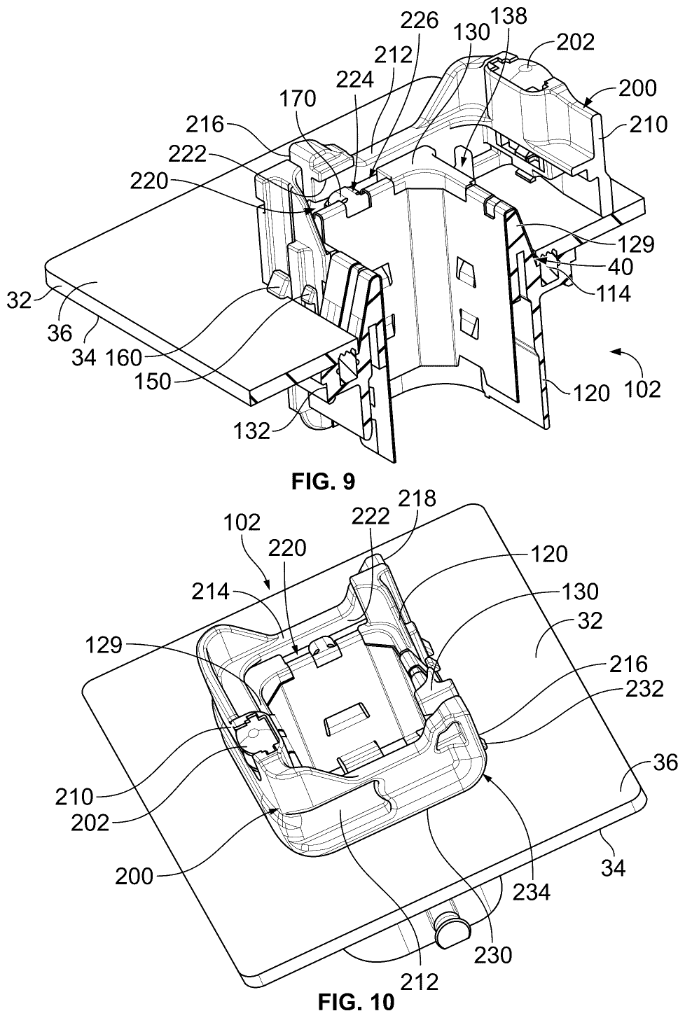

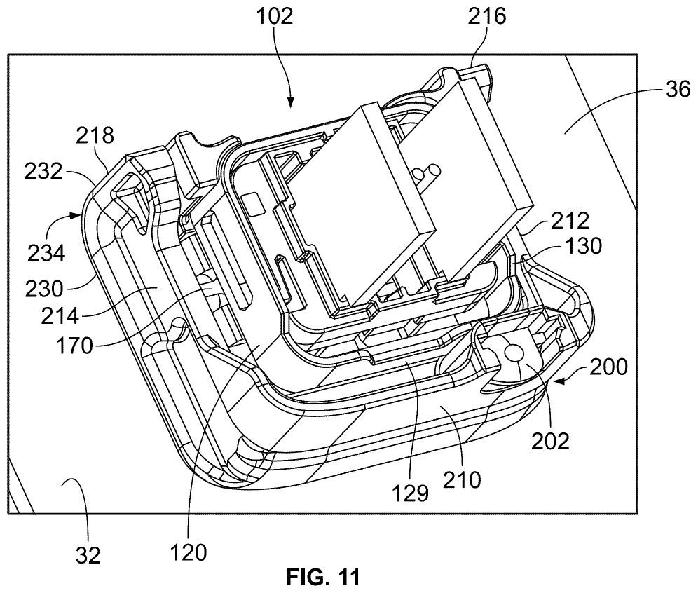

FIG. 7 is a bottom perspective view of a portion of the header connector 102 showing the locking lever 200 in an open position. FIG. 8 is a bottom perspective view of a portion of the header connector 102 showing the locking lever 200 in a closed position. FIG. 9 is a sectional view of a portion of the header connector 102 showing the locking lever 200 in the closed position and in an extended position. FIG. 10 is a bottom perspective view of a portion of the header connector 102 showing the locking lever 200 in a retracted position. FIG. 11 is a bottom perspective view of a portion of the header connector 102 showing the locking lever 200 in a locked position.

During assembly, the header housing 120 is initially coupled to the panel 32 by plugging the base 130 through the opening 40. The pre-stage latches 150 engage the panel 32 to hold the header housing 120 in the pre-stage position (FIG. 7). The locking lever 200 may be coupled to the header housing 120 when the header housing 120 is in the pre-stage position. The final stage latches 160 are not latchably coupled to the panel 32 in the pre-stage position. Rather, the final stage latches 160 may be located in the opening 40 of the panel 32 or above the upper surface 34 of the panel 32. After the locking lever 200 is actuated (for example, closed, the header housing 120 is moved from the pre-stage position to the final stage position. The header housing 120 is moved downward from the pre-stage position to the final stage position. For example, the flange 132 is moved toward the panel 32 causing the final stage latches 160 to pass through the opening 40 and interface with the lower surface 36 of the panel 32. The final stage latches 160 are latchably coupled to the panel 32 in the final stage position (FIG. 8). The final stage latches 160 may prevent the header housing 120 from moving relative to the panel 32 when the final stage latches 160 are coupled to the panel 32. The pre-stage latches 150 may be located a first distance from the flange 132 and the final stage latches 160 may be located a second distance from the flange 132. The second distance may be less than the first distance such that the flange 132 is located closer to the panel 32 when the final stage latches 160 are coupled to the panel 32 compared to the pre-stage latches 150.

During mounting of the header connector 102 to the panel 32, the locking lever 200 is moved from the open position to the closed position and then removed from the extended position to the retracted position. The locking lever 200 may be locked to the header housing 120 in the retracted position. In an exemplary embodiment, the locking lever 200 is rotated between the open position and the closed position, such as by rotating the handle 210 toward the panel 32 to the closed position. The rotating action between the open position in the closed position causes the header connector 102 to be seated on the panel 32. For example, the flange 132 is moved toward the panel 32 and seated on the upper surface 34 of the panel 32 to compress the seal 114 and create a sealed connection between the flange 132 and the panel 32. In an exemplary embodiment, the locking lever 200 is slid forward between the extended position and the retracted position. The locking lever 200 is slid forward to the retracted position by pressing the handle 210 toward the rear 129 of the header housing 120 to lock the locking lever 200 relative to the header housing 120. In the locked position, the locking lever 200 is prevented from opening, thus holding the header housing 120 tightly against the panel 32 to maintain the sealed connection between the header housing 120 and the panel 32.

In an exemplary embodiment, the lever arms 212, 214 each include a pin channel 220 that receives the lever pin 170. The pin channel 220 is provided along an interior surface 222 of the corresponding lever arms 212, 214. The pin channel 220 is open at the corresponding distal end 216, 218 to receive the lever pin 170. In an exemplary embodiment, the pin channel 220 includes a pin pocket 224 and a pin track 226 extending from the pin pocket 224. When the lever pin 170 is located in the pin pocket 224, the locking lever 200 is rotatable on the lever pin 170. For example, the locking lever 200 may be rotated between the open and closed positions when the lever pin 170 is in the pin pocket 224. When the locking lever 200 is in the closed position, the lever pin 170 is slidable in the pin track 226. The locking lever 200 is configured to slide between the extended position and the retracted position by sliding the lever pin 170 in the pin track 226.

In an exemplary embodiment, the locking lever 200 includes an inner edge 230 and a front edge 232 extending along each of the lever arms 212, 214. The locking lever 200 includes a fulcrum 234 between the inner edge 230 and the front edge 232. In the illustrated embodiment, the fulcrum 234 is curved between the inner edge 230 and the front edge 232. The front edge 232 is configured to face the panel 32 in the open position. The front edge 232 may engage the lower surface 36 of the panel 32 in the open position. The inner edge 230 is configured to face the panel 32 in the closed position. The inner edge 230 is a top edge of the lever arm 212, 214 in the illustrated embodiment. The inner edge 230 may engage the lower surface 36 of the panel 32 in the closed position. The fulcrum 234 is configured to engage the panel 32 as the locking lever 200 is rotated between the open position in the closed position. The locking lever 200 is rotated relative to the header housing 120 between a first position (open position) and a second position (closed position). The header housing 120 is moved relative to the panel 32 as the fulcrum 234 rotates on the panel 32. For example, the lever action induced by the locking lever 200 between the panel 32 and the header housing 120 causes the header housing 120 to move downward relative to the panel 32 as the locking lever 200 is rotated from the open position to the closed position. In an exemplary embodiment, the front edge 232 is located closer to the pin pocket 224, thus the lever pin 170 than the inner edge 230. As the fulcrum 234 is rotated along the panel 32 (when the locking lever 200 is rotated from the open position to the closed position), the lever pin 170 is pushed downward further away from the panel 32 by the locking lever 200, which causes the header housing 120, and thus the flange 132, to move downward. The seal 114 is compressed between the flange 132 and the upper surface 34 of the panel 32 as the fulcrum 234 rotates on the panel 32 from the open position to the closed position. To keep the locking lever 200 and the closed position, and prevent the handle 210 of the locking lever 200 from returning to the open position, the locking lever 200 is moved forward to the retracted position (FIG. 10) and then locked (FIG. 11) in the retracted position.

In the retracted position, the handle 210 is adjacent the rear 129 of the base 130. In an exemplary embodiment, the base 130 of the header housing 120 includes a locking pocket 138. The locking element 202 of the locking lever 200 is configured to be received in the locking pocket 138 to secure the locking lever 200 relative to the header housing 120 in the locked position.

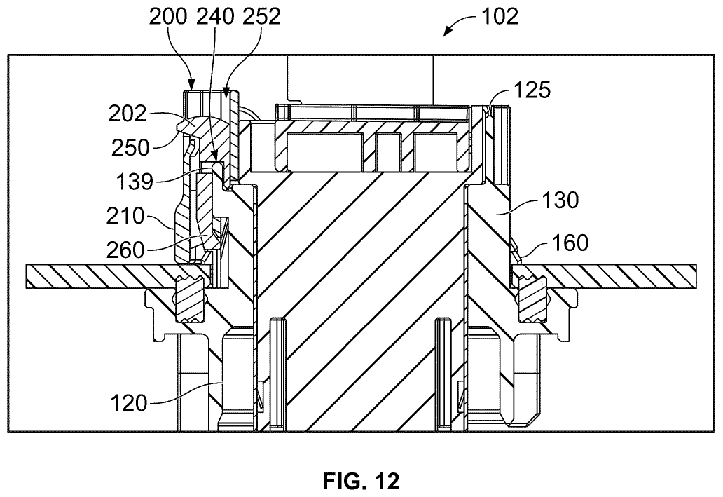

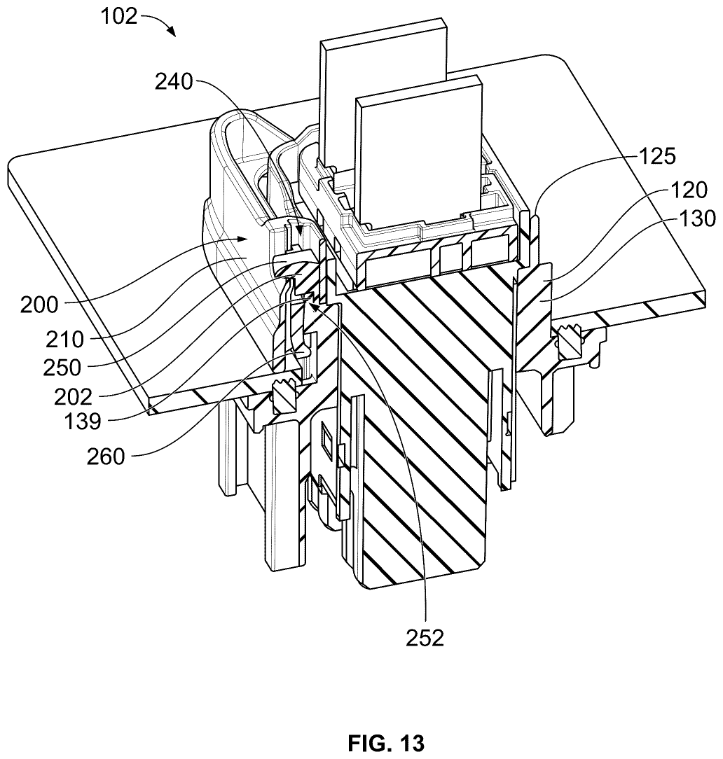

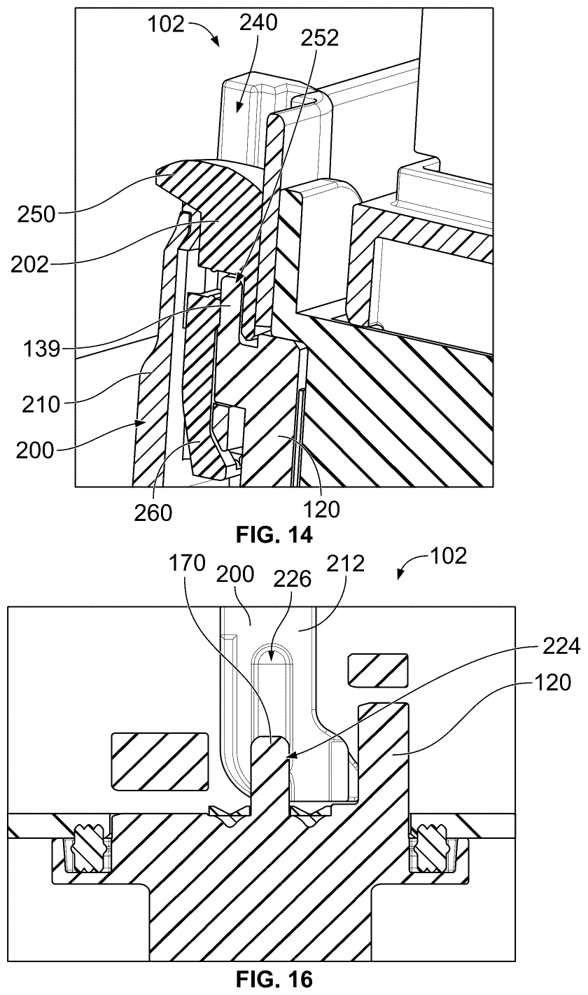

FIG. 12 is a cross-sectional view of a portion of the header connector 102 showing the locking lever 200 in a locked position in accordance with an exemplary embodiment. FIG. 13 is a cross-sectional view of a portion of the header connector 102 showing the locking lever 200 in a locked position in accordance with an exemplary embodiment. FIG. 14 is a cross-sectional view of a portion of the header connector 102 showing the locking lever 200 in a locked position in accordance with an exemplary embodiment.

In an exemplary embodiment, the locking lever 200 includes a locking element pocket 240 in the handle 210. The locking element 202 is received in the locking element pocket 240. In an exemplary embodiment, the locking element 202 is movable within the locking element pocket 240, such as between an unlocked position and a locked position. In the illustrated embodiment, the locking element 202 may be pushed downward from the unlocked position to the locked position. The locking element 202 is locked to the header housing 120 in the locked position. The locking element 202 is unlocked from the header housing 120 in the unlocked position. The locking lever 200 is restricted from moving relative to the header housing 120 (for example sliding to the extended position or rotating to the open position) in the locked position. The locking lever 200 is free to move relative to the header housing 120 (for example, sliding to the extended position) in the unlocked position.

In an exemplary embodiment, the locking element 202 includes a button 250 at a bottom of the locking element 202 and a cavity 252 at a top of the button 250. The header housing 120 includes a locking tab 139, such as at the bottom 125 of the base 130. The locking tab 139 is received in the cavity 252 when the locking element 202 is moved to the locked position. For example, when the button 250 is pressed upward to the locked position, the locking tab 139 is received in the cavity 252. The locking lever 200 is unable to move away from the header housing 120 when the locking tab 139 is received in the cavity 252. Other types of locking features may be used in alternative embodiments.

In an exemplary embodiment, the locking element 202 includes a latch beam 260 extending from the button 250. The latch beam 260 is configured to interface with the header housing 120. The latch beam 260 may hold the locking lever 200 and the locked position in various embodiments, the latch beam 260 may engage the one of the final stage latches 160 to prevent the final stage latch 160 from unlatching. For example, the latch beam 260 may operate as a secondary latching feature for the final stage latch 160.

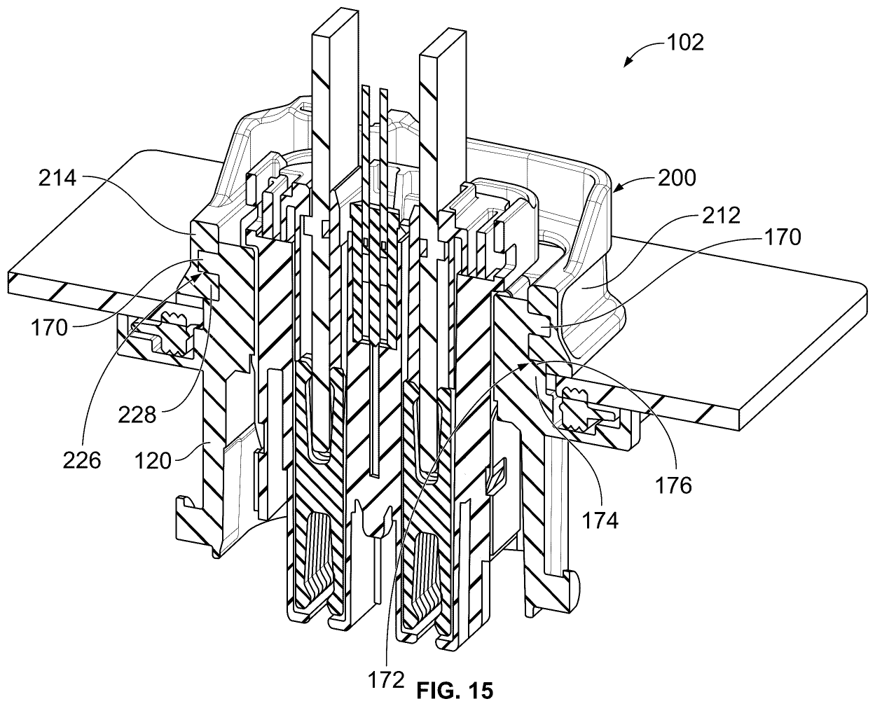

FIG. 15 is a cross-sectional view of a portion of the header connector 102 in accordance with an exemplary embodiment. FIG. 15 shows the lever pin 170 located in the pin track 226. The lever pin 170 is slidable in the pin track 226. The lever arms 212, 214 are received in the guide track 172 between the guide surface 176 of the guide rail 174 and the lever pin 170. For example, a locking rib 228 of the locking lever 200 is located in the guide track 172 and is movable in the guide track 172 to guide movement of the locking lever 200 relative to the header housing 120. The guide tracks 172 and the pin tracks 226 guide movement of the locking lever 200 relative to the header housing 120. For example, the guide tracks 172 and the pin tracks 226 guide the sliding movement in a horizontal sliding direction. Other types of guide features may be used in alternative embodiments.

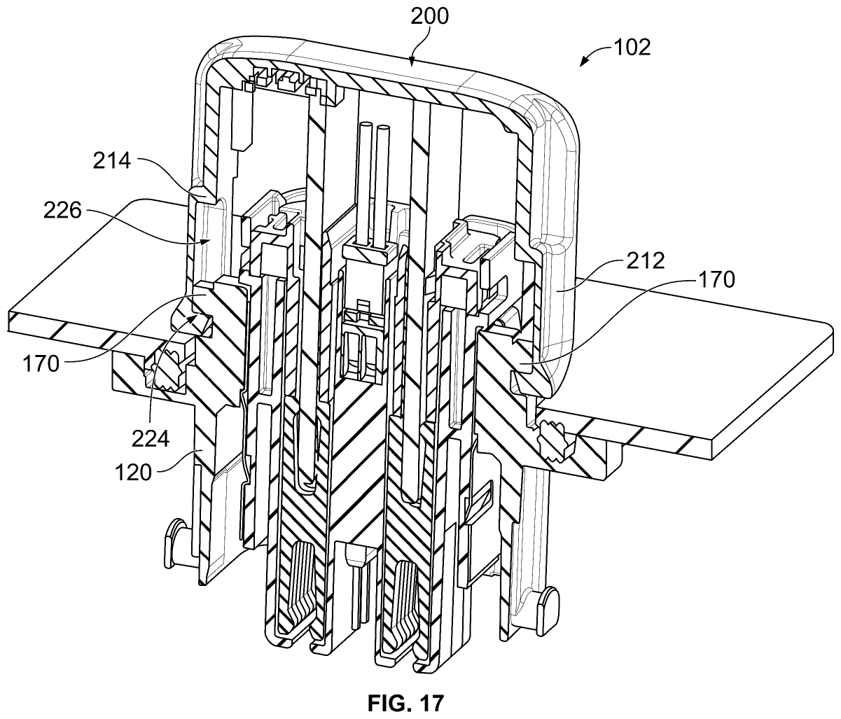

FIG. 16 is a cross-sectional view of a portion of the header connector 102 in accordance with an exemplary embodiment. FIG. 17 is a cross-sectional view of a portion of the header connector 102 in accordance with an exemplary embodiment. FIGS. 16 and 17 show the pin tracks 226 and the pin pockets 224 in the lever arms 212, 214 of the locking lever 200. The lever pins 170 of the header housing 120 are shown in the pin pockets 224 and aligned with the pin tracks 226.

In an aspect, an electrical connector is provided including a housing extending between a mating end and a mounting end. The mating end is configured to be mated with a mating electrical connector. The mating end includes a shroud surrounding a cavity. The mounting end is configured to be mounted to a panel. The mounting end includes a base and a flange extending from the base. The base of the housing is received in an opening in the panel. The flange of the housing is mounted to a mounting surface of the panel. A contact assembly is received in the housing. The contact assembly includes a contact holder holding at least one contact configured to be mated to the mating electrical connector. A seal is coupled to the flange and surrounds the base. The seal configured to interface with the mounting surface of the panel. A locking lever is coupled to the housing. The locking lever is configured to interface with the panel to secure the housing to the panel.

Optionally, the locking lever may secure the housing to the panel without the use of fasteners.

Optionally, the locking lever may be rotatably coupled to the housing.

Optionally, the locking lever may be slidably coupled to the housing.

Optionally, the locking lever may move relative to the housing between a first position and a second position. The locking lever may move the housing relative to the panel to compresses the seal when the locking lever is moved from the first position to the second position.

Optionally, the housing may include a pre-stage latch and a final stage latch. The flange of the housing may be moved relatively closer to the mounting surface of the panel from a pre-stage position to a final stage position. The pre-stage latch may be latchably coupled to the panel in the pre-stage position. The final stage latch may be latchably coupled to the panel in the final stage position.

Optionally, the locking lever may be actuated to move the housing from the pre-stage position to the final stage position.

Optionally, the pre-stage latch may be located a first distance from the flange and the final stage latch may be located a second distance from the flange. The second distance may be less than the first distance.

Optionally, the base includes lever pins extending outward from the base, the locking lever includes pin pockets that receive the lever pins.

Optionally, the locking lever may be rotatably coupled to the lever pins.

Optionally, the base may include a guide track. The locking lever may include a locking rib received in the guide track to secure the locking lever relative to the housing.

Optionally, the locking lever may include a locking element. The locking element may be actuated to lock the locking lever to the housing.

Optionally, the base of the housing may include a locking pocket. The locking lever may include a locking element being received in the locking pocket to secure the locking lever relative to the housing.

Optionally, the locking lever may include a fulcrum configured to engage the panel. The locking lever may be rotated relative to the housing between a first position and a second position. The housing may be moved relative to the panel as the fulcrum rotates on the panel.

Optionally, the locking lever may be pivotably coupled to the housing to move from a vertical position to a horizontal position. The locking lever may be slidably coupled to the housing to move from a first horizontal position to a second horizontal position.

Optionally, the locking lever may include a handle, a first lever arm extending from a first side of the handle, and a second lever arm extending from a second side of the handle. The first lever arm may be coupled to a first side of the base and the second lever arm may be coupled to a second side of the base. The handle may be actuated to move the first and second lever arms relative to the housing.

Optionally, the handle may be pivoted relative to the housing from an open position to a closed position. The handle may be remote from the panel in the open position and the handle may engage the panel in the closed position. The first and second arms may move the flange closer to the panel as the handle is pivoted from the open position to the closed position.

Optionally, the handle may be slid relative to the housing from an extended position to a retracted position. The handle may be spaced apart from the base in the extended position. The handle may engage the base in the retracted position. The handle may be configured to be locked to the base in the retracted position.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing extending between a mating end and a mounting end, the mating end configured to be mated with a mating electrical connector, the mating end including a shroud surrounding a cavity, the mounting end configured to be mounted to a panel, the mounting end including a base and a flange extending from the base, the base of the housing being received in an opening in the panel, the flange of the housing being mounted to a mounting surface of the panel;
a contact assembly received in the housing, the contact assembly including a contact holder holding at least one contact configured to be mated to the mating electrical connector;
a seal coupled to the flange and surrounding the base, the seal configured to interface with the mounting surface of the panel; and
a locking lever coupled to the housing, the locking lever configured to interface with the panel to secure the housing to the panel.

2. The electrical connector of claim 1, wherein the locking lever secures the housing to the panel without the use of fasteners.

3. The electrical connector of claim 1, wherein the locking lever is rotatably coupled to the housing.

4. The electrical connector of claim 1, wherein the locking lever is slidably coupled to the housing.

5. The electrical connector of claim 1, wherein the locking lever moves relative to the housing between a first position and a second position, the locking lever moves the housing relative to the panel to compresses the seal when the locking lever is moved from the first position to the second position.

6. The electrical connector of claim 1, wherein the housing includes a pre-stage latch and a final stage latch, the flange of the housing is moved relatively closer to the mounting surface of the panel from a pre-stage position to a final stage position, the pre-stage latch being latchably coupled to the panel in the pre-stage position, the final stage latch being latchably coupled to the panel in the final stage position.

7. The electrical connector of claim 6, wherein the locking lever is actuated to move the housing from the pre-stage position to the final stage position.

8. The electrical connector of claim 6, wherein the pre-stage latch is located a first distance from the flange and the final stage latch is located a second distance from the flange, the second distance being less than the first distance.

9. The electrical connector of claim 1, wherein the base includes lever pins extending outward from the base, the locking lever includes pin pockets that receive the lever pins.

10. The electrical connector of claim 9, wherein the locking lever is rotatably coupled to the lever pins.

11. The electrical connector of claim 1, wherein the base includes a guide track, the locking lever includes a locking rib received in the guide track to secure the locking lever relative to the housing.

12. The electrical connector of claim 1, wherein the locking lever includes a locking element, the locking element being actuated to lock the locking lever to the housing.

13. The electrical connector of claim 1, wherein the base of the housing includes a locking pocket, the locking lever includes a locking element being received in the locking pocket to secure the locking lever relative to the housing.

14. The electrical connector of claim 1, wherein the locking lever includes a fulcrum configured to engage the panel, the locking lever being rotated relative to the housing between a first position and a second position, the housing being moved relative to the panel as the fulcrum rotates on the panel.

15. The electrical connector of claim 1, wherein the locking lever is pivotably coupled to the housing to move from a vertical position to a horizontal position, the locking lever is slidably coupled to the housing to move from a first horizontal position to a second horizontal position.

16. The electrical connector of claim 1, wherein the locking lever includes a handle, a first lever arm extending from a first side of the handle, and a second lever arm extending from a second side of the handle, the first lever arm being coupled to a first side of the base, the second lever arm being coupled to a second side of the base, the handle being actuated to move the first and second lever arms relative to the housing.

17. The electrical connector of claim 16, wherein the handle is pivoted relative to the housing from an open position to a closed position, the handle is remote from the panel in the open position and the handle engages the panel in the closed position, the first and second arms moving the flange closer to the panel as the handle is pivoted from the open position to the closed position.

18. The electrical connector of claim 17, wherein the handle is slid relative to the housing from an extended position to a retracted position, the handle is spaced apart from the base in the extended position, the handle engages the base in the retracted position, the handle is configured to be locked to the base in the retracted position.

19. An electrical connector comprising:
a housing extending between a mating end and a mounting end, the mating end configured to be mated with a mating electrical connector, the mating end including a base surrounding a cavity, the mounting end configured to be mounted to a panel, the mounting end including a base and a flange extending from the base, the base of the housing being received in an opening in the panel, the flange of the housing being mounted to a mounting surface of the panel, wherein the housing includes a pre-stage latch and a final stage latch, the flange of the housing is moved relatively closer to the mounting surface of the panel from a pre-stage position to a final stage position, the pre-stage latch being latchably coupled to the panel in the pre-stage position, the final stage latch being latchably coupled to the panel in the final stage position;
a contact assembly received in the housing, the contact assembly including a contact holder holding at least one contact configured to be mated to the mating electrical connector;
a seal coupled to the flange and surrounding the base, the seal configured to interface with the mounting surface of the panel; and
a locking lever coupled to the housing, the locking lever configured to interface with the panel to secure the housing to the panel, wherein the locking lever is actuated to move the housing from the pre-stage position to the final stage position.

20. An electrical connector comprising:
a housing extending between a mating end and a mounting end, the mating end configured to be mated with a mating electrical connector, the mating end including a base surrounding a cavity, the mounting end configured to be mounted to a panel, the mounting end including a base and a flange extending from the base, the base of the housing being received in an opening in the panel, the flange of the housing being mounted to a mounting surface of the panel;
a contact assembly received in the housing, the contact assembly including a contact holder holding at least one contact configured to be mated to the mating electrical connector;
a seal coupled to the flange and surrounding the base, the seal configured to interface with the mounting surface of the panel; and
a locking lever coupled to the housing, the locking lever configured to interface with the panel to secure the housing to the panel, wherein the locking lever includes a locking element, the locking element being actuated to lock the locking lever to the housing.
